(19) United States
(12) Patent Application Publication
(10) Pub. No.: US 2010/0306060 A1
(43) Pub. Date: Dec. 2, 2010

(54) METHOD FOR ADVERTISING USING MOBILE DEVICES

(76) Inventors: Scott Yancey, Carmel, IN (US); Jordan Chase Crafton, Indianapolis, IN (US)

Correspondence Address: ICE MILLER LLP, ONE AMERICAN SQUARE, SUITE 3100, INDIANAPOLIS, IN, 46282-0200, US

(21) Appl. No.: 12/791,645

(22) Filed: Jun. 1, 2010

Related U.S. Application Data
(60) Provisional application No. 61/182,969, filed on Jun. 1, 2009.

(51) Int. Cl. G06Q 30/00

(52) U.S. Cl. 705/14.64

(57) ABSTRACT

A method for advertising using mobile devices is disclosed. According to one embodiment of the disclosure, a method for advertising using mobile devices includes syncing at least one identifier code to the phone number of a mobile device, wherein the at least one identifier code corresponds to data encoded on the integrated circuit of an RFID tag. The method also includes receiving a first keyword at a target phone number from the phone number of the mobile device and associating the phone number of the mobile device and the at least one identifier code to at least one advertising program based at least partially upon the first keyword. The method further includes producing one or more incentive messages based at least upon the detection of the data encoded on the RFID tag.

### CROSS REFERENCE TO RELATED APPLICATION

This application claims the benefit of and incorporates by reference herein the disclosure of U.S. Ser. No. 61/182,969, filed Jun. 1, 2009.

### BACKGROUND

Advertising has taken many forms over the years, including magazines, newspapers, and the World Wide Web, to name a few. Advertisers are always looking for new places and ways of reaching consumers. Recently, mobile devices have become an integral part of many persons' daily activities. As a result, advertisers are interested in effective ways of getting their messages to consumers using mobile devices. Accordingly, there exists a need for improved ways of advertising using mobile devices.

### SUMMARY

The present disclosure discloses a method for advertising using mobile devices. One embodiment of a method for advertising using a mobile device includes syncing at least one identifier code to the phone number of a mobile device, wherein the at least one identifier code corresponds to data encoded on the integrated circuit of an RFID tag. The method also includes receiving a first keyword at a target phone number from the phone number of the mobile device and associating the phone number of the mobile device and the at least one identifier code to at least one advertising program based at least partially upon the first keyword. The method further includes producing one or more incentive messages relating to said at least one advertising program based at least upon the detection of the data encoded on the RFID tag.

In another embodiment of a method for advertising using a mobile device, the method includes providing a database containing at least one or more identifier codes, one or more phone numbers, and one or more advertising programs, wherein at least one of the one or more identifier codes is paired with one of the one or more phone numbers and wherein at least one of the one or more advertising programs is associated with the at least one of the one or more identifier codes and the one of said one or more phone numbers that is paired with the at least one of the one or more identifier codes. The method also includes detecting a first identifier code from a first RFID tag and determining whether the first identifier code of the first RFID tag is associated with the one or more advertising programs. The method further includes producing a first incentive message corresponding to the at least one of the one or more advertising programs if at least the first identifier code is determined to be associated with the at least one of the one or more advertising programs.

In another embodiment of a method for advertising using a mobile device, the method includes receiving at least one identifier code to a target phone number from the phone number of a mobile device and pairing the phone number of the mobile device to the at least one identifier code in a database, wherein the at least one identifier code corresponds to data encoded on the integrated circuit of an RFID tag. The method also includes transmitting a list message to the phone number of the mobile device, wherein the list message contains a list of commercial establishments. The method further includes receiving a selection message containing one or more selections from the list of commercial establishments and associating the phone number of the mobile device and the at least one identifier code to at least one advertising program based at least partially upon the one or more selections. The method also includes producing one or more incentive messages relating to the one or more selections based at least upon the detection of the data encoded on the RFID tag.

### BRIEF DESCRIPTION OF THE DRAWINGS

The features and advantages of this disclosure, and the manner of attaining them, will be more apparent and better understood by reference to the following descriptions of the disclosed method, taken in conjunction with the accompanying drawings, wherein:

FIG. 1 shows a method for advertising using mobile devices according to at least one embodiment of the present disclosure.

FIG. 2 illustrates the step of syncing of the method of FIG. 1.

FIGS. 3-4 show flow charts of rules governing opting in to an advertising program and tethering a mobile device to an identifier code according to at least one embodiment of the present disclosure.

FIG. 5 shows a method for advertising using mobile devices according to at least one embodiment of the present disclosure.

FIG. 6 shows a method for advertising using mobile devices according to at least one embodiment of the present disclosure.

FIG. 7 shows a method for advertising using mobile devices according to at least one embodiment of the present disclosure.

FIGS. 8-13 show web-based interfaces enabling entities to start and manage an advertising campaign or program according to at least one embodiment of the present disclosure.

FIG. 14 shows a flow chart involving dispatching events for a campaign according to at least one embodiment of the present disclosure.

FIGS. 15-17 show reports involving mobile users and coupon redemption statistics of advertising programs and campaigns according to one embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

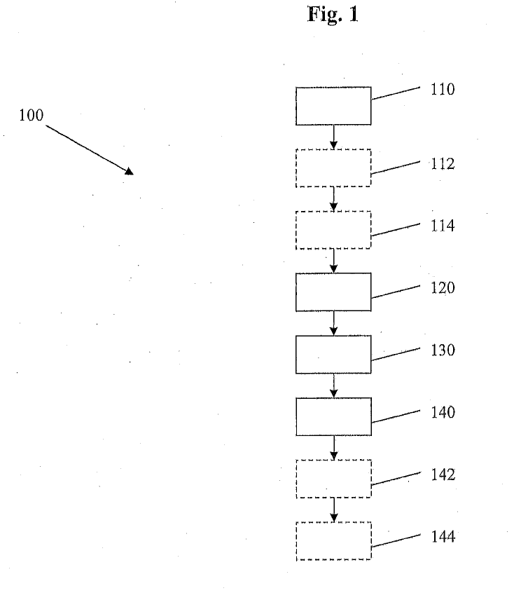

As shown in FIG. 1, one embodiment of a method for advertising using mobile devices 100 includes syncing (herein referred to as “tethering”) an identifier code to the phone number of a mobile device 110, receiving a first keyword at a target phone number from the phone number of the mobile device 120, and associating the phone number of the mobile device and the at least one identifier code to at least one advertising program based at least partially upon the first keyword 130. The method 100 also includes producing one or more incentive messages relating to the at least one advertising program based at least upon the detection of the data encoded on the RFID tag 140.

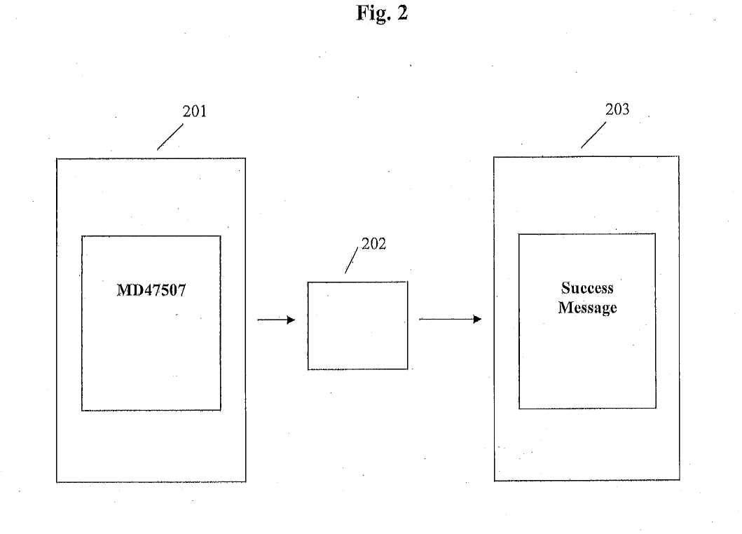

The step of syncing a mobile device to an identifier code 110 typically begins with the user sending a unique identifier code to a short code or other telephone number. The unique identifier code represents numbers and/or letters encoded on a Radio Frequency Identification (RFID) tag's integrated circuit. The user may send the identifier code using any type of mobile device, such as a mobile telephone or the like. After sending the identifier code to a short code, the user's phone number and the unique identifier code may then be received by a web server and paired within a database. That is, his or her phone number (and by association the mobile device) may now be considered to be tethered to the identifier code of the RFID tag. Optionally, after the mobile device is tethered to the identifier code of the RFID tag 110, a success response may be sent via text message, email, or the like to the user from the web server 114. For example, as shown in FIG. 2, an identifier code (“MD47507”) is sent to a short code using a mobile device 201. In FIG. 2, after tethering the phone number of the mobile device to the identifier code, a success response (“Success”) is sent back to the same mobile device (shown as device 203) via a web server 202 and displayed thereon. It should be noted that the system may allow for the tethering of multiple unique identifier codes to a single phone number. In other words, multiple RFID tags may be tethered to a single mobile device.

After tethering the mobile device to the identifier code of an RFID tag, in order to receive alerts such as advertisements, incentives, and the like, the user may typically need to “opt in” to a particular campaign by sending a specific keyword to a short code or other telephone number. This is shown in step 120 of method 100 in FIG. 1. After sending the keyword to a short code, the user's phone number and the unique identifier code may then be received by a web server and associated to the particular campaign or program connected to the keyword and/or short code within a database. This is shown by step 130 of method 100 in FIG. 1. As shown in step 112 of method 100 of FIG. 1, the user may also be required to submit his or her zip code to opt in to a particular campaign. By opting in, the user effectively signs up to receive mobile media correspondence from a particular business or entity running a campaign or program. By knowing the current zip code of the user, targeted advertisements for that particular zip code region may be provided to the user. For example, if a user opted in to a national restaurant or business chain, then the supplied user zip code would provide the national chain (advertising entity) with the ability to send targeted, local promotions to those users with the local zip code and/or nearby zip codes. While FIG. 1 shows step 112 (receipt of zip code) occurring before step 114 (transmitting success message), it should be noted that the order of these steps may be reversed or that only one of these steps (or neither of them) may be included in the method 100. Optionally, the user may “opt out” of any campaign by, for example, submitting a particular keyword to a short code (step 142 of FIG. 1). By opting out, a user effectively disassociates his or her mobile device and identifier code with a particular campaign or program (step 144 of FIG. 1). A user may also opt out (or opt in) of a campaign using the World Wide Web (including the user's mobile web), a telephone, and the like. For example, a web interface may be used by users to opt in or opt out of promotions, such as through the use of usernames and passwords and/or selection bubbles.

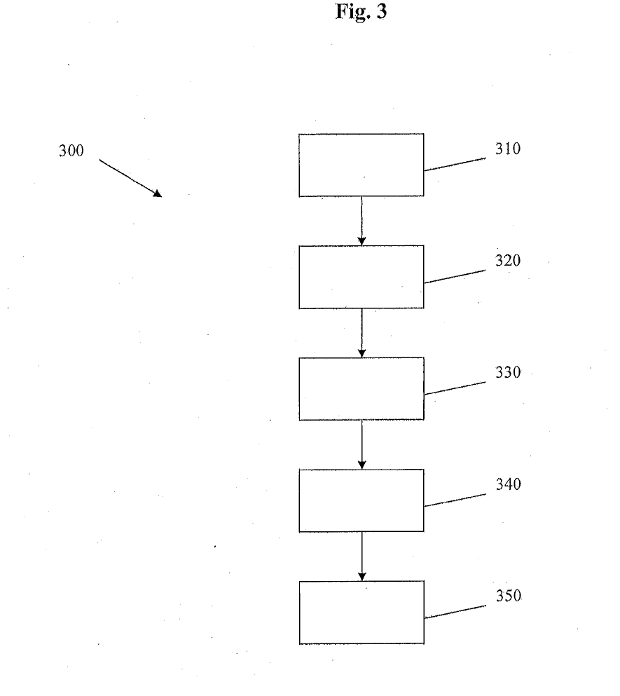

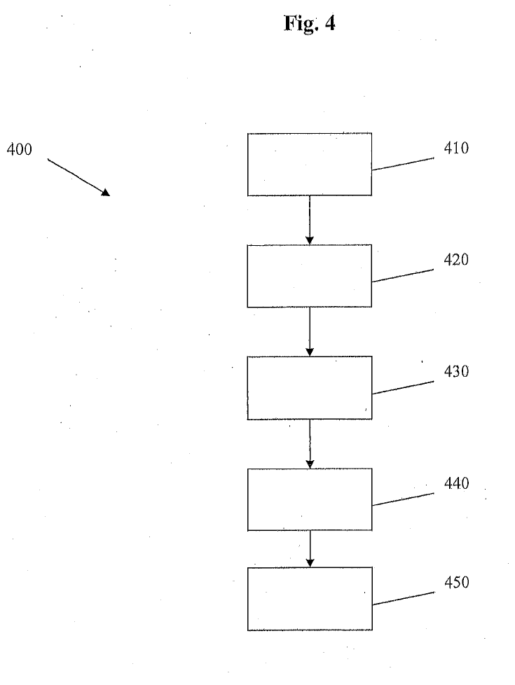

FIGS. 3-4 show exemplary flow charts regarding opting in and tethering. FIG. 3 shows a flow chart of a method for opting in 300. As shown in FIG. 3, the method 300 includes receiving a keyword at a short code 310 and determining if the keyword is valid 320. For instance, if the predefined keywords are “burger” and “fries,” then any other keyword may be ignored as invalid or an error message may be sent back to the user that sent the improper keyword. If the received keyword is determined to be proper, then method 300 next determines if the mobile device is already opted in. That is, if the mobile device has already been opted in, then the user may be sent a message stating that he or she is already opted in. However, if the mobile device has not been opted in, then method 300 next opts in the mobile device (and corresponding unique identifier code) 340 and sends the user a successful opt in message 350. Of course, other steps may be included in method 300 or one or more of the steps discussed above may be removed.

FIG. 4 shows a flow chart of a method for tethering a mobile device to an identifier code 400. As shown in FIG. 4, the method 400 includes receiving a message from a phone number 410 and determining if the message includes a valid identifier code 420. If the message is determined to include a valid identifier code, then method 400 next determines if the mobile device (using the phone number) has already been tethered to the identifier code 430. If the mobile device and identifier code have not already been tethered, then method next tethers the mobile device (using the phone number) to the unique identifier code 440 and sends the user a message indicating the tethering process was successful 450. Of course, other steps may be included in method 400 or one or more steps discussed above may be removed.

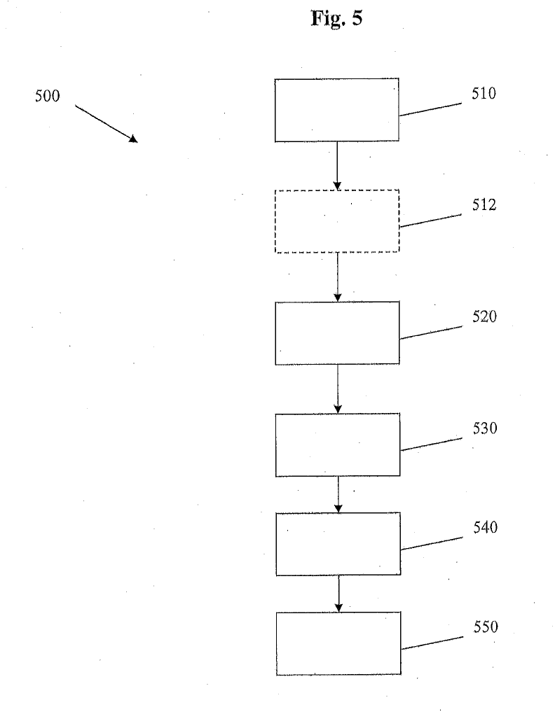

It should be noted that in some cases, after tethering a phone number of a mobile device to an identifier code of an RFID tag, the user may receive alerts on his or her mobile device soliciting the user to join a particular campaign. For example, as shown in FIG. 5, a method for advertising using mobile devices 500 includes receiving at least one identifier code to a target phone number from the phone number of a mobile device and pairing the phone number of the mobile device to the at least one identifier code in a database 510, as well as transmitting a list message to the phone number of the mobile device 520. The method 500 may optionally include the step of receiving a zip code 512. It should be noted that step 512 may occur at various other times in method 500, not just after the tethering step 510. The list message may contain a list of commercial establishments, which may be specific to the received zip code information. The method 500 also includes receiving a selection message containing one or more selections from the list of commercial establishments 530 and associating the phone number of the mobile device and the at least one identifier code to at least one advertising program based at least partially upon the one or more selections 540. The method 500 also includes producing one or more incentive messages relating to the one or more selections based at least upon the detection of the data encoded on one or more RFID tags 550.

A user may find campaigns and their respective short codes and keywords in various places and forms, such as on the World Wide Web, in newspapers or magazines, at a restaurant or place of business, and the like. As noted above, some campaigns may automatically be registered for the user upon tethering his or her mobile device. For example, the user may be prompted to choose his or her favorite restaurants, clothing stores, and the like in order to complete the tethering process. Based upon the user's selections, the user's mobile may be automatically opted in to certain campaigns.

Referring back to method 100 of FIG. 1, once a mobile device is tethered to an identifier code and the user opts in (voluntarily or involuntarily) to at least one campaign, alerts for advertisements, price incentives, promotions, sweepstakes, payment, loyalty programs, and other enticements are dispatched through various channels, such as SMS, MMS, E-mail, Instant Messages, and the like relating to such campaigns 140. For example, if a user opts in to a campaign for an ice cream parlor, the user may receive alerts like “Buy one cone, get one free” or “Spend $10 get 30% off a cake” for that ice cream parlor. As further described below, the alerts may include barcodes or other features that facilitate redeeming the offer in the alert. A user may be sent an alert directly through electronic channels (e.g., SMS, MMS, E-mail, Instant Messages) to inform the user that an incentive can be redeemed using his or her RFID tag at a participating business. Accordingly, after opting in (or even after just tethering a mobile device), a user's mobile device may receive alerts including advertisements, incentives, coupons, promotions, sweepstakes, payment, or loyalty programs.

It should be noted that persons other than just customers or potential customers of a business may receive alerts. For example, employees of a business may receive notifications relating to current promotions of that business. Also, employees may receive alerts such as incentives for signing up the most users for a campaign or the like.

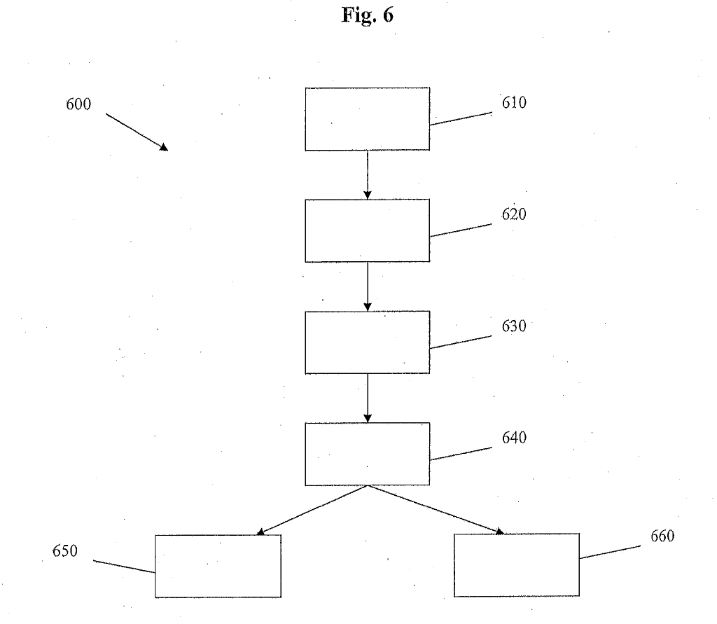

A user may receive campaign alerts, such as coupons, whenever he or she presents or scans his or her RFID tag in a participating business. For instance, by simply placing his or her RFID tag near an RFID reader of a participating business, a user may trigger an alert to be sent to the user's mobile device. FIG. 6 shows one example of a method for advertising using mobile devices that includes detecting an RFID tag and generating a coupon or the like 600. As shown in FIG. 6, the positioning of the RFID tag near the RFID reader 610 may generate a signal, which may include the identifier code. The signal may be transmitted to a computer or the like 620. Through the World Wide Web or the like, the computer may communicate with a Web Server and Campaign Manager 630. The Campaign Manager may access a Database 640 to determine what, if any, advertisements and incentives should be provided for the detected identifier code. For instance, the Campaign Manager and Database may be configured to search for coupons or the like only pertaining to the store in which the RFID reader is housed. Furthermore, only those incentives relating to items to be purchased by the user may be chosen (e.g., instant savings). The signal may then be passed from the Campaign Manager to the computer and finally the Printer, where the coupon is issued 650. This process of reading a tag and printing a coupon in response thereto is sometimes referred to as the voucher process. The voucher, which may be a coupon, provides a paper trail for the vendor to keep track of discounts in the same way physical coupons are used in accounting today. The process of recognizing an identifier code of an RFID tag that is tethered to a mobile device allows for the intelligent distribution of coupons or other loyalty programs.

As shown in FIG. 6, after the Campaign Manager consults with the Database, advertisement or coupon data is sent to the computer and subsequently a coupon is printed at the Printer. In this way, coupons may be printed out at a Point of Sale (POS). Alternatively, as shown in FIG. 6, alerts from the Campaign Manager may be sent to a wireless carrier and subsequently forwarded to a mobile device 660. For example, the alerts may be received via SMS or MMS technologies. After receiving the alerts on their mobile devices, users may print out a coupon, present the coupon with barcode on the mobile device, and the like.

In some cases, an advertising entity may only want to send advertisements and the like to a specific set of users. Alerts, advertisements, coupons, and the like may be sent to specific users based upon various attributes regarding users. For instance, information about users learned during the tethering process, opt in process, and/or use of respective RFID tags may provide advertising entities with the parameters to identify particular users that should receive certain messages.

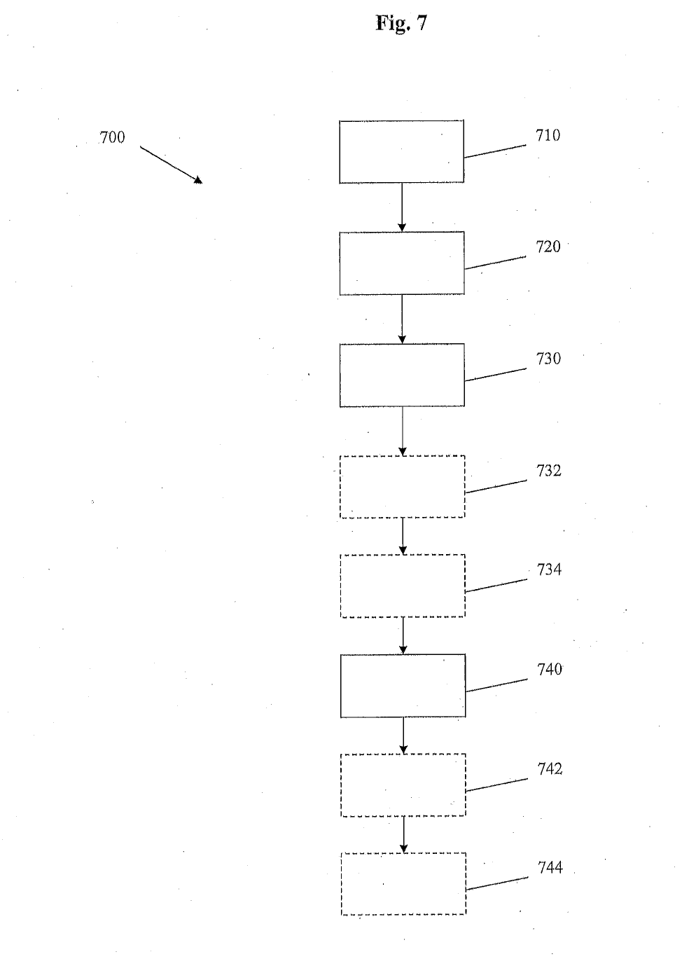

In FIG. 7, another embodiment of a method for advertising using mobile devices 700 is shown. The method 700 includes providing a database 710 containing at least one or more identifier codes, one or more phone numbers, and one or more advertising programs, wherein at least one of the one or more identifier codes is paired with one of the one or more phone numbers and wherein at least one of the one or more advertising programs is associated with the at least one of the one or more identifier codes and the one of said one or more phone numbers that is paired with the at least one of the one or more identifier codes. Of course, the database may be configured in any manner as known in the art and the initial associations and pairings may be created as described above. The method 700 also includes detecting a first identifier code from a first RFID tag 720 and determining whether the first identifier code of the first RFID tag is associated with the one or more advertising programs 730. The method 700 further includes producing a first incentive message corresponding to the at least one of the one or more advertising programs if at least the first identifier code is determined to be associated with the at least one of the one or more advertising programs 740. The method 700 may optionally include one or more of the steps of determining whether the first incentive should be produced 732, accessing an incentive database 734, validating the first incentive message 742 (discussed below), and collecting and reporting advertising statistics 744 (discussed below).

A kiosk may be provided at a participating business or other venue. The kiosk may be configured to read RFID tags, print off discounts or coupons, and the like. For example, a user may walk into a participating business and waive his or her RFID tag in front of an RFID scanner at the kiosk. The kiosk may then produce a response, such as an image on a screen, lights, sounds, or the like, indicating that the user is entitled to a coupon. The kiosk may then print a coupon or the like, which may be presented to the cashier during the checkout process to be redeemed. The kiosk may be wired or wirelessly connected to a network. Accordingly, the kiosk may communicate with various databases and web servers to provide the most relevant incentives for the individual. The kiosk may be programmed to perform various functions, including displaying various advertisements and producing redeemable incentives.

The redemption of the various incentives may be accomplished in many ways. For example, as described above, an incentive may be redeemed by providing a sales clerk with a printout of a coupon or by scanning a barcode displayed on the user's mobile device. Once scanned or otherwise entered, an incentive may be validated via a remote database or a server. In some cases, the advertising entity may actually have a database that resides with the advertising entity and that contains all the valid coupons. As such, validation may occur with this server. In other cases, the database may be separate from the advertising entity, such as at a marketing firm. In either case, the process may be able to compare a user's current and previous activity to ensure no coupon or incentive is used twice. Generally, all codes are unique to each individual user to prevent duplication of the code and identity theft. Furthermore, the real-time redemption and validation of incentives by the process may provide an added layer of security and protection.

As discussed above, the alerts of campaigns offered to a user may include coupons, loyalty programs, sweepstakes, rewards programs, and the like. The advertisements and the like may be sent to users at any time and in any frequency. As stated above, the alerts may be sent to the user via SMS, MMS, Email, World Wide Web, Instant Messaging, and the like. As mentioned above, the alerts may be sent in response to the behavior of a user, such as on the occurrence of the user putting his or her RFID tag near an RFID reader. Alternatively, alerts may be sent at predetermined times, such as the first Monday of each month. In other words, the alerts may be sent according to a calendar or appointment system. A web server or the like may be used to schedule the distribution of alerts, including the time, market, region, and the like. Of course, alerts, such as advertisements, may be sent simply at the behest of an advertising entity at any time to any user, such as when a new promotion is unveiled. As described above, the advertising entity may also send information or incentives to his or her employees. These incentives may be particular to the employees, such as a special employee discount.

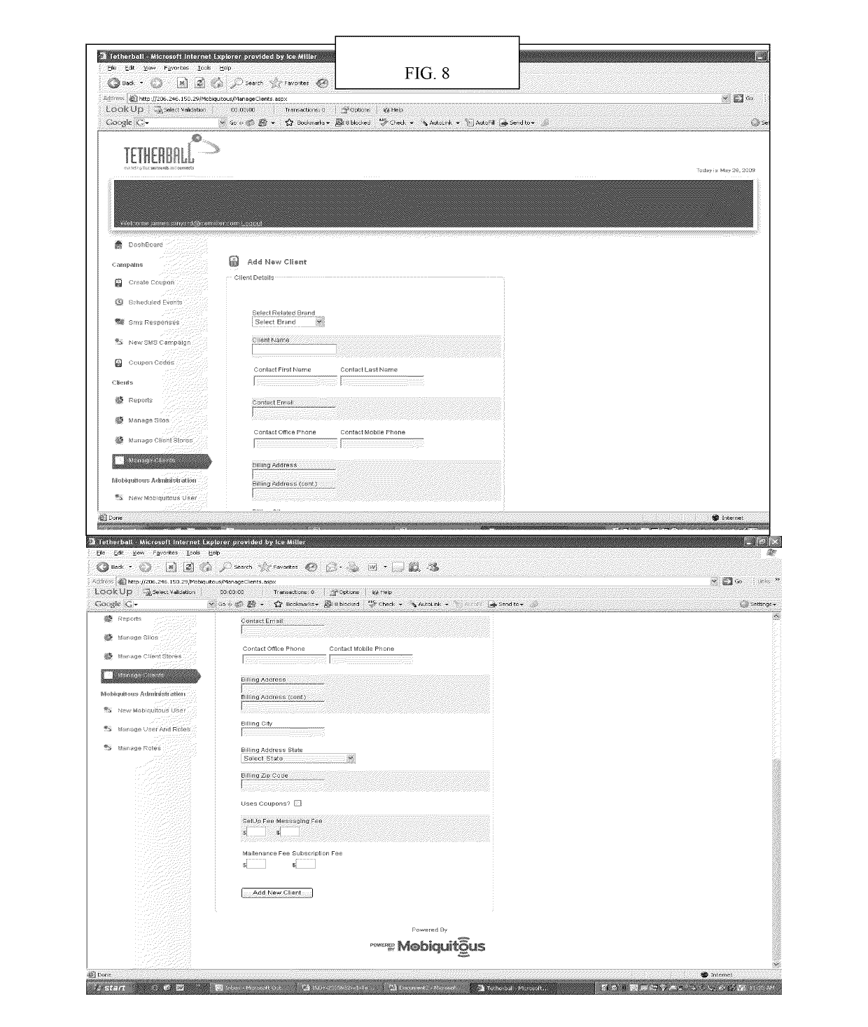

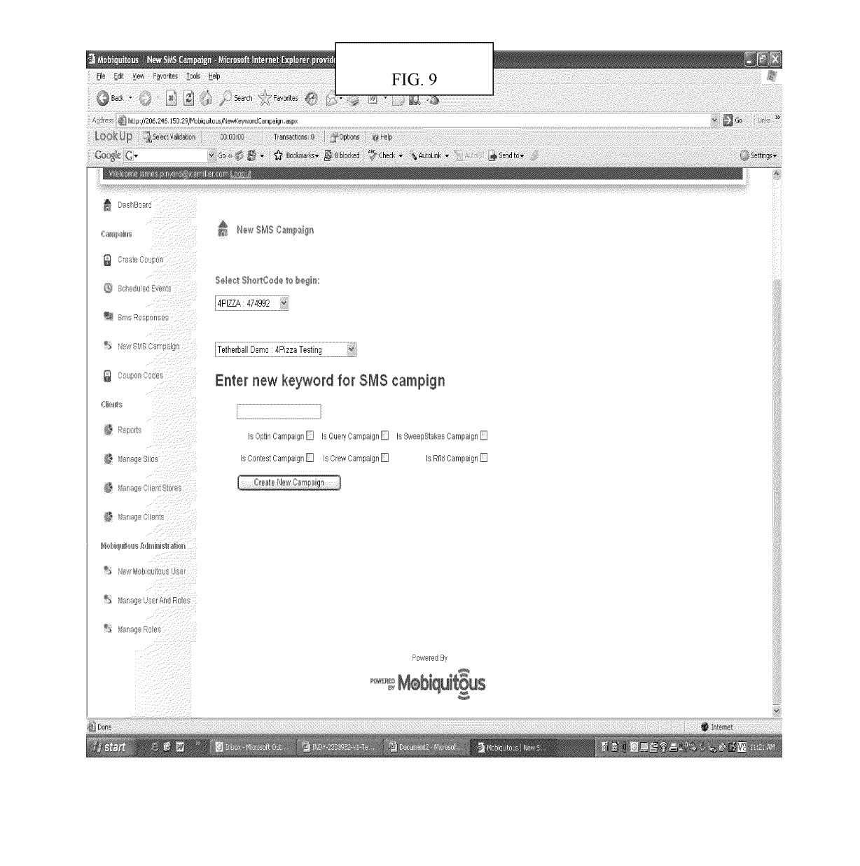

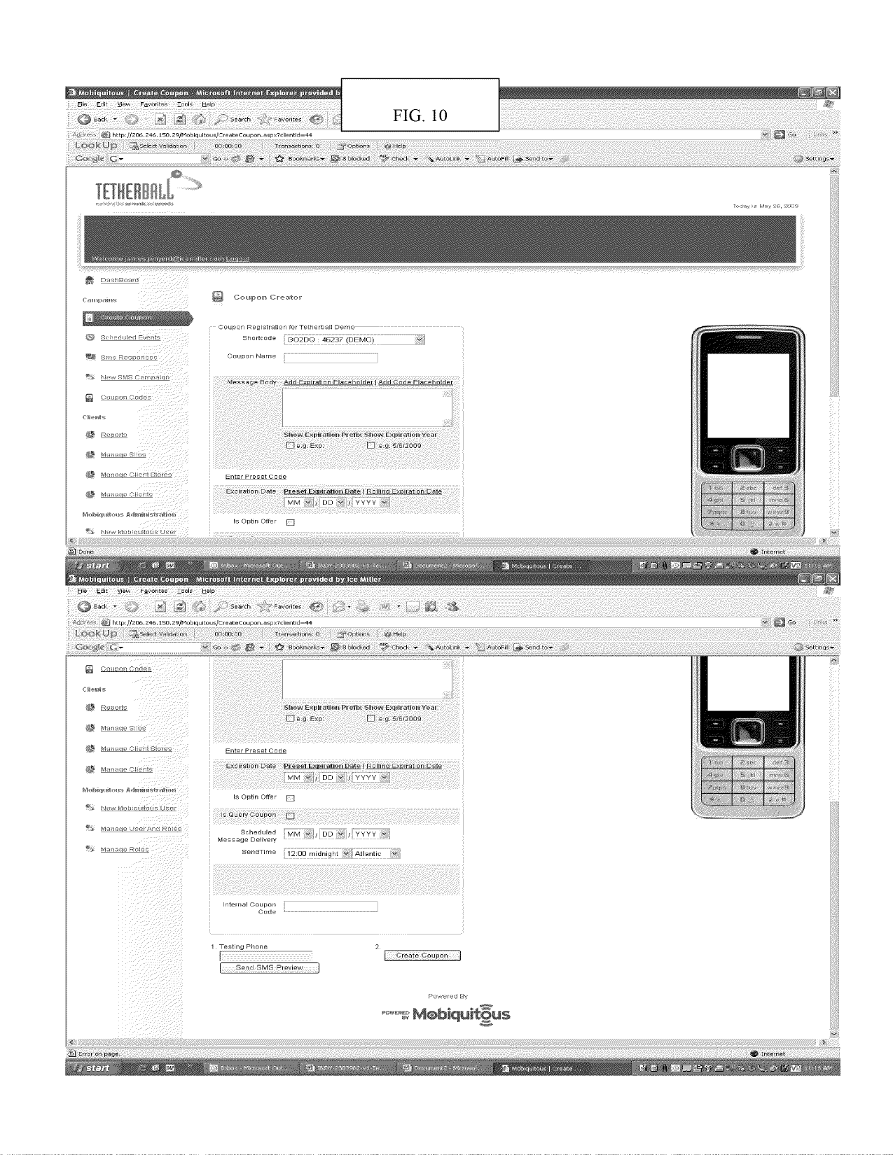

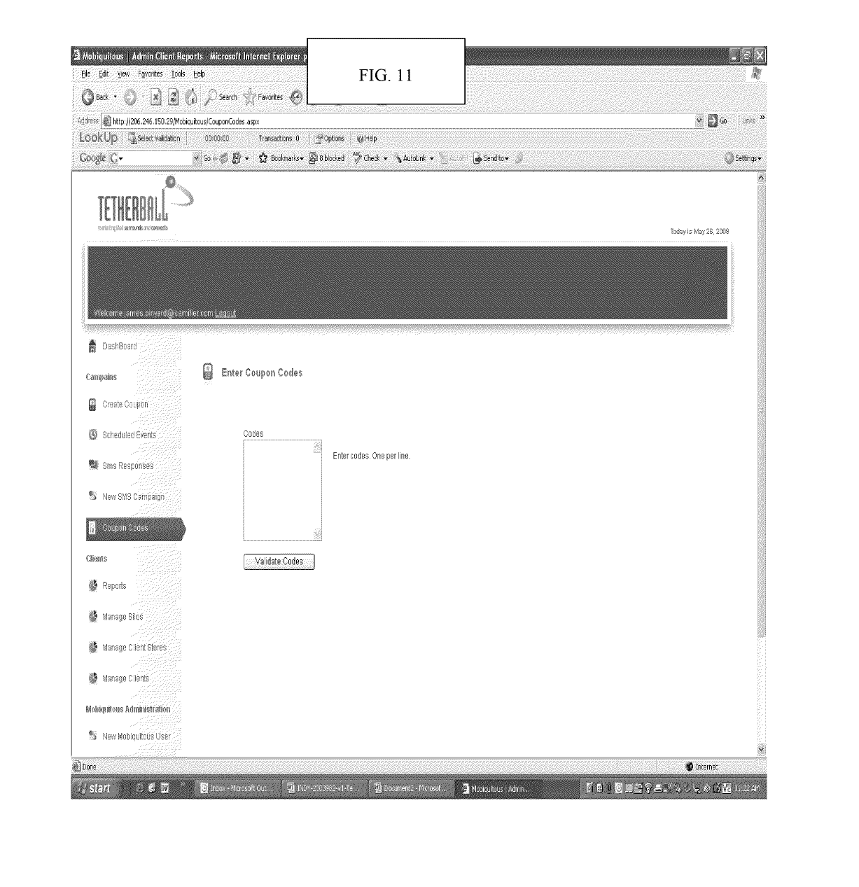

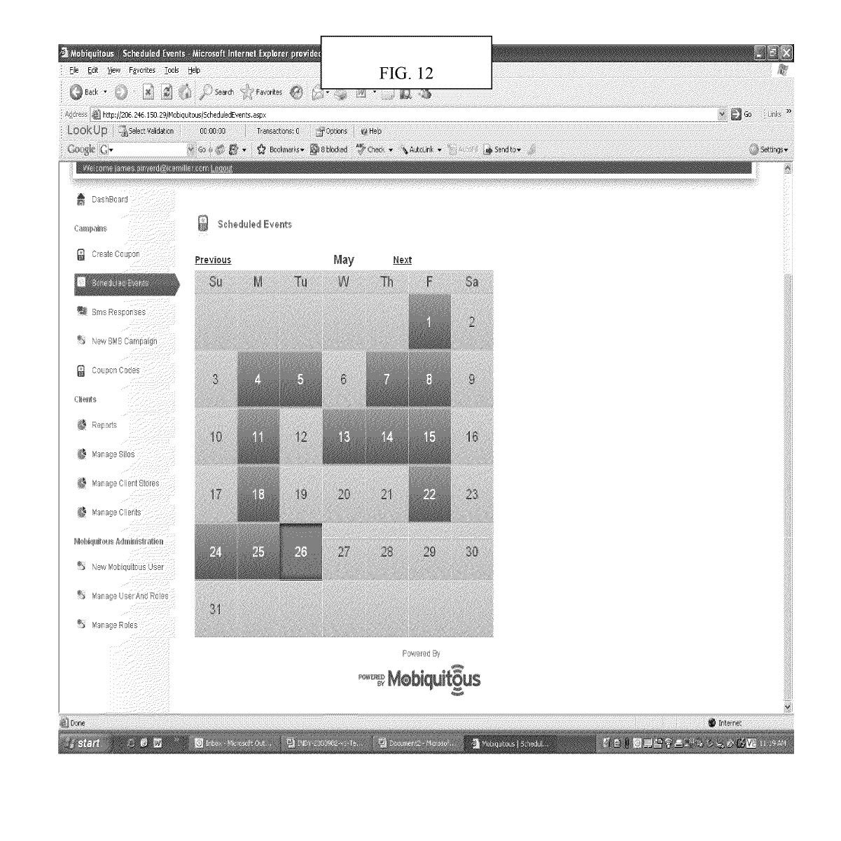

In order for an advertising entity to become a client and create an advertising program or campaign, the entity may need to complete a new client form, such as the one shown in FIG. 8. Once the entity is a registered client of the advertising program, a business owner or manager for the advertising entity may choose what type of advertisement they want their customers to be exposed to and manage a campaign as he or she sees fit. As shown in FIG. 9, a campaign may be created based on a short code and a keyword. Once a campaign is created, an alert (such as an advertisement, incentive, and the like) may be created by the advertising entity using various types of computer interfaces (e.g., a campaign manager, marketing software, etc.) and subsequently storing the alert creations in a database. In FIG. 10, for example, a web-based form is provided allowing for an advertising entity to create a coupon and select when the coupon alert is dispatched. Furthermore, in FIG. 11, a list of valid coupon codes may be entered, which may be used by the system to ensure that the same coupon code is only used once. The alert itself may include a computer form that is configurable in terms of words and designs. For instance, a computer form may include “Buy 1 get 1 free cone” superimposed over an image of an ice cream cone. In some cases, once the parameters for an alert are set, a barcode, such as an Aztec barcode, may be assigned and superimposed on the words, media, and/or blank space of the alert. The advertising entity may create unique offers for one user or a few users in particular, such as for the highest volume shoppers. After creating the advertisement, the product may then be sent to the user, immediately or at a scheduled time. As shown in FIG. 12, an advertising entity may be able to keep track of past, present, and future events using an interactive calendar.

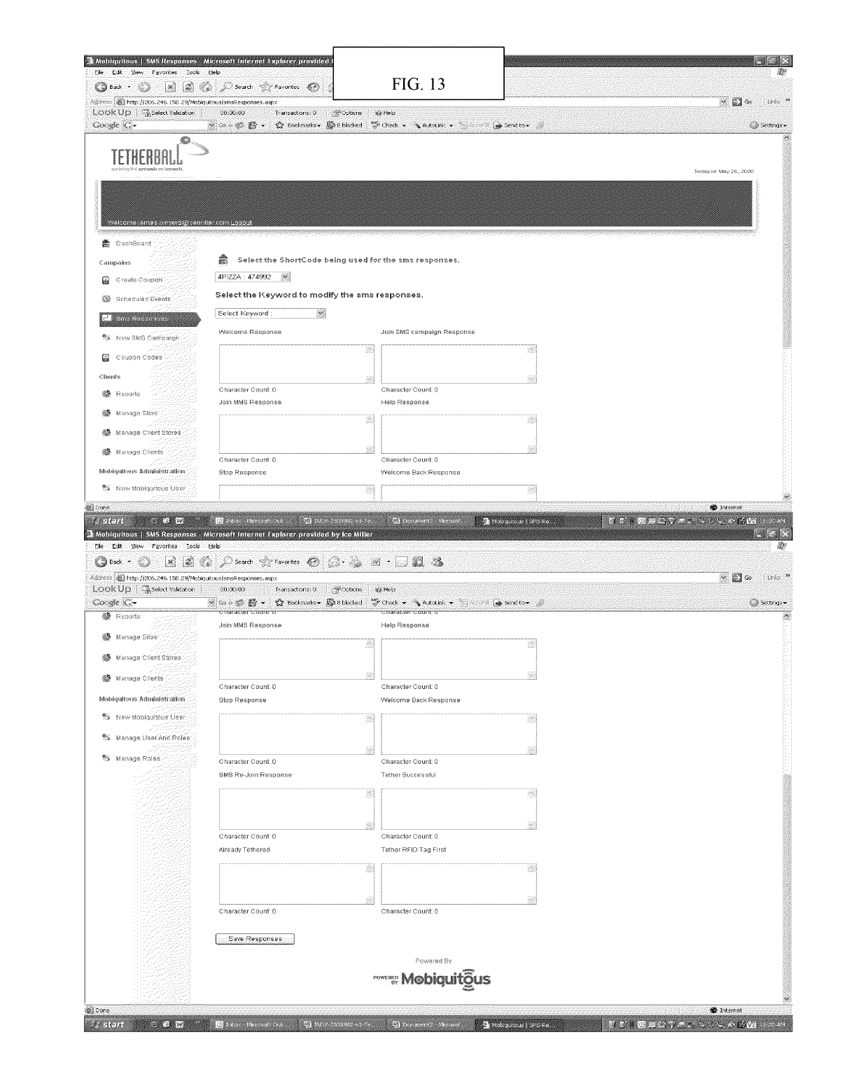

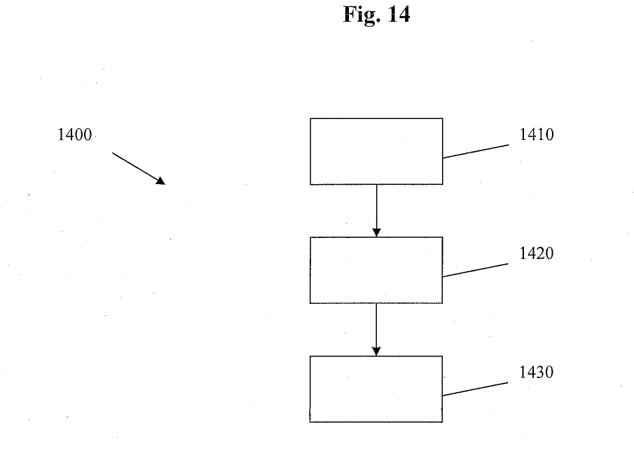

In creating advertisements, the system may allow for an advertising entity to handle uploading media and copying files for a certain campaign, assign keywords associated with a campaign, and select the market and/or region for the campaign to be distributed in, as well as the time and date when a campaign should be initiated. For example, as shown in FIG. 13, an advertising entity may choose the responses to be sent to users when a particular short code and keyword are submitted by a user. Furthermore, the advertising entity may use a computer to pass advertisements, incentives, and the like along to a wireless carrier. The advertisements, incentives, and the like may then be transmitted to mobile consumers. For example, FIG. 14 shows the steps taken by the system beginning with a scheduled event (or alert) and ending with the posting of a coupon (or delivery of the coupon to a mobile device). In FIG. 14, a flow chart of a method for dispatching events for a campaign is shown 1400. The method 1400 includes receiving an event for a campaign from an advertising entity 1410. As described above, an event or coupon may be created using various web-interfaces and the like. After receiving the event, method 1400 next retrieves information (e.g., phone numbers) for those users that are opted in to the particular campaign 1420 and delivers the event or coupon to the opted in users 1430. For example, the event or coupon may be emailed or sent via text message to the users.

In addition to tethering and administering alerts, analytical data may be collected in real-time. Based upon the analytical data collected from the detection of RFID tags and dispatching of alerts (e.g., coupons), where, when, and what kind of advertisements, loyalty programs, and the like have been distributed and redeemed may be determined. This may be referred to as a “closed loop” system. Using the analytical data gathered, an individual user, specific coupons, and the like may be tracked. Furthermore, the system may instantaneously know the success of any promotion running at any given time, which may provide information on what is the best promotion for each user or a group of users.

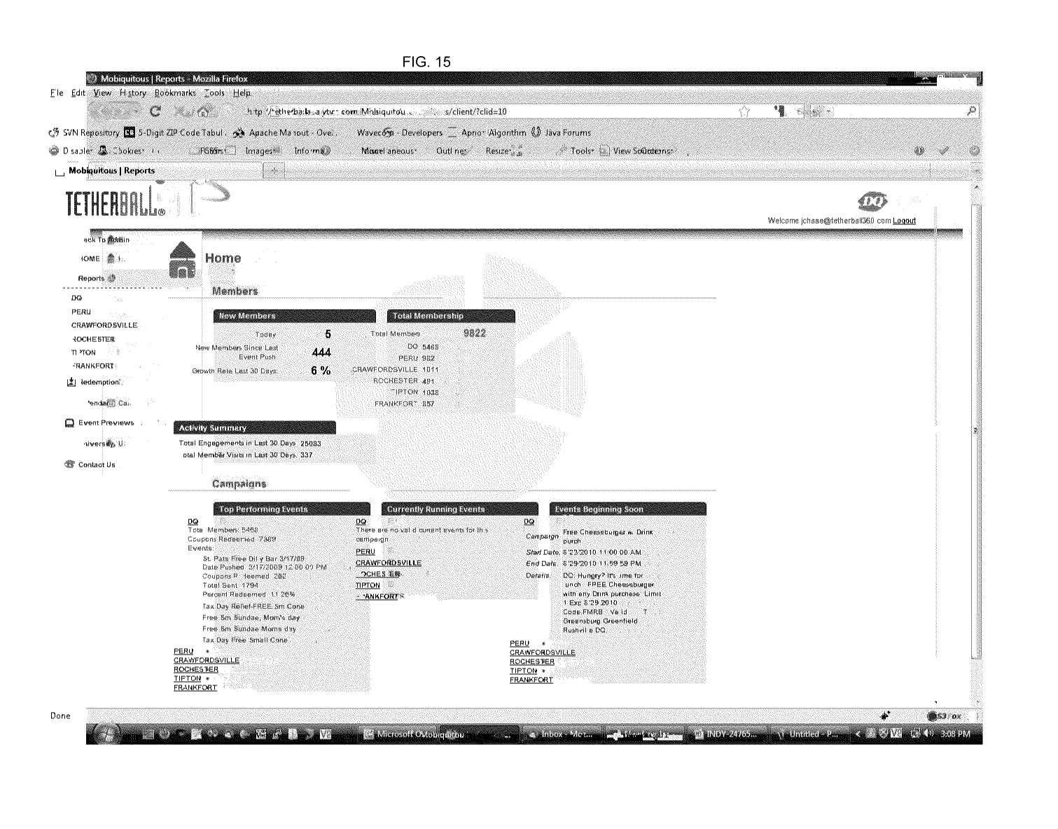

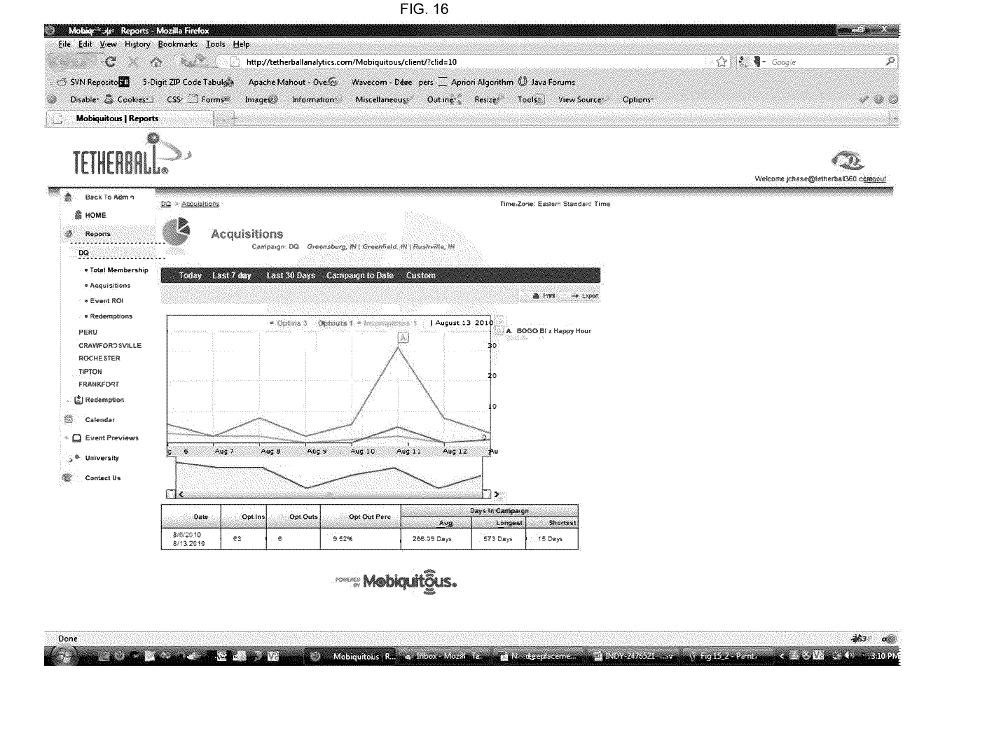

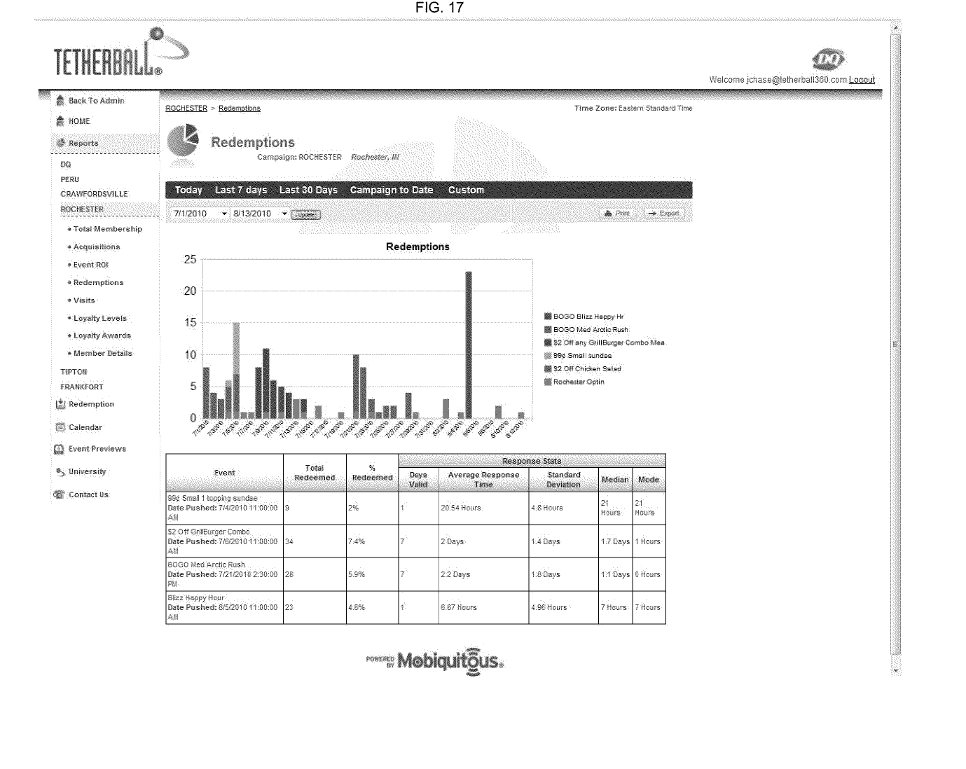

A report including the usage statistics of each coupon along with the various details that relate to the coupon may be generated based upon the analytical information collected. For instance, a report may show what was redeemed, when it was redeemed, and how it was redeemed. As shown in FIGS. 15-17, Web interfaces may display the total membership of a campaign, new members across various time frames, events (alerts) pushed to the user, total opt-ins and opt-outs, and redemption rates, among other statistics. A report may provide data on the messages sent by keyword, market, region, city, store, and the like. In addition, a report may dynamically create a graph that shows the comparison of the coupons delivered and the coupons actually redeemed. Also, a report may show statistics siloed by keyword and/or market. A report may also provide detailed reports with respect to specific users, incentives, campaigns, and the like. The results reported, such as usage and statistics, may be displayed on a web form (see, for example, FIGS. 15-17), SMS, MMS, or email message, kiosk display, and the like. It should be noted that the collection of data and production of reports may help business owners or entities determine when, where, and what advertising promotions should be offered to a user in real-time.

Various types of RFID tags may be used in the advertising program, such as High Frequency (HF) tags and Ultra High Frequency (UF) tags. Location based programs may be able to recognize UF RFID tags at great distances. For example, when a user walks into a place of business, the system may automatically recognize the user's presence by detecting the UF RFID tag and subsequently sending an incentive to the user's mobile device. A varying frequency RFID tag may be used, for instance, when it is required to identify and communicate with users at a variety of specific distances. In these cases, the user may not be required to present his or her RFID tag close to an RFID tag reader. On the other hand, near field programs may utilize HF RFID tags which require a user to present the tag in close proximity to an RFID tag reader. Near field programs may commonly be used at the time of redeeming an incentive or completing part of a promotion that is managed by the process. It should also be noted that RFID tags may be encoded such that they only relate to particular programs and behaviors.

RFID tags may have various structures. An RFID tag may be physically attachable to the mobile device via fasteners, tacky material, and other attachment systems. Alternatively, the RFID tag may be integrated with the mobile device. An RFID tag may include rubber or other material that assists in attaching or securing the RFID tag to a mobile device. Of course, RFID tags may have various shapes and sizes but may typically be sized to fit on the back side of most mobile devices. For example, an RFID tag may be circular in shape and roughly the size of a nickel coin of U.S. currency. Also, an RFID tag may be encased within a tag carrier and have usage instructions attached thereon. RFID tags may include any type of design and/or wording.

The RFID tags may be read by various types of RFID readers as known in the art. As stated above, the RFID readers may be located near a POS, at a kiosk, and other locations, such as next to clothing racks in a department store or positioned just above the entrance of a store. It should be noted that a particular RFID reader may be created to meet the needs of a user. For instance, an RFID reader may be specially designed to be used with a drive-thru window and capable of withstanding the elements outdoors. Of course, various other types of specialized RFID readers may be provided.

After a user tethers his or her mobile device to an identifier code, the user may be able to access one or more online games which may provide discounts and other incentives based on the user's performance and/or participation. For example, by having the highest score of the day in a particular game, the user may get a free ice cream cone at an ice cream parlor, which may be redeemed by scanning the user's RFID tag near the RFID tag reader at the ice cream parlor.

A user that has opted in to a campaign may be used to obtain viral growth for membership into that campaign. For instance, a user that has opted in to a campaign may receive a special code from the campaign to be forwarded to the user's contacts. Each contact may join the campaign by sending the special code via text message to a particular number. For each new member that joins, the original user may be given incentives, including, but not limited to, loyalty points and rewards.

After tethering a mobile device and RFID tag (as described above), the tethered mobile device may be used to place the user in a queue or place a reservation, such as at a restaurant or other establishment that requires the patrons to check-in and the like. For example, upon arriving at a restaurant, the user may tap the RFID tag attached to the user's mobile device to an RFID reader at the restaurant, which effectively identifies the user to the restaurant. It should be noted that the user may identify himself or herself by sending an identifier (e.g., phone number, email address, and/or name to the restaurant). After determining what phone number, email address, and/or phone number corresponds to the RFID tag, the restaurant may place that user in a queue for an available table at which to be seated. Once the restaurant is ready to seat or service the user, the user would be alerted via their mobile device through an electronic message or phone message. In order to maintain a quiet atmosphere, the restaurant may choose to only send electronic messages to effectively and discreetly communicate to those waiting to hear that their table is ready. Alternatively, when the restaurant is ready to seat or service the user, a worker at the restaurant may call out the name of the user.

While this disclosure has been described as having various embodiments, these embodiments according to the present disclosure can be further modified within the scope and spirit of this disclosure. This application is therefore intended to cover any variations, uses, or adaptations of the disclosure using its general principles. For example, any methods disclosed herein and in the appended documents represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

1. A method of advertising using a mobile device, the method comprising:
syncing at least one identifier code to the phone number of a mobile device, wherein said at least one identifier code corresponds to data encoded on the integrated circuit of an RFID tag;
receiving a first keyword at a target phone number from the phone number of said mobile device;
associating the phone number of said mobile device and said at least one identifier code to at least one advertising program based at least partially upon said first keyword; and
producing one or more incentive messages relating to said at least one advertising program based at least upon the detection of said data encoded on said RFID tag.

2. The method of claim 1, wherein the step of syncing said at least one identifier to the phone number of said mobile device comprises receiving said at least one identifier code to said target phone number and pairing the phone number of said mobile device to said at least one identifier code in a database.

3. The method of claim 2, wherein said target phone number comprises a short code.

4. The method of claim 2, further comprising receiving a second keyword at said target phone number from the phone number of said mobile device and disassociating the phone number of said mobile device and said at least one identifier code from said at least one advertising program based at least partially upon said second keyword.

5. The method of claim 1, further comprising transmitting a confirmation message to the phone number of said mobile device after syncing said at least one identifier code to the phone number of said mobile device.

6. The method of claim 5, wherein said confirmation message comprises a text message.

7. The method of claim 1, further comprising receiving zip code information at said target phone number from the phone number of said mobile device.

8. The Method of claim 1, wherein said one or more incentive messages comprises an e-mail.

9. A method of advertising using a mobile device, the method comprising:
providing a database containing at least one or more identifier codes, one or more phone numbers, and one or more advertising programs, wherein at least one of said one or more identifier codes is paired with one of said one or more phone numbers and wherein at least one of said one or more advertising programs is associated with said at least one of said one or more identifier codes and said one of said one or more phone numbers that is paired with said at least one of said one or more identifier codes;
detecting a first identifier code from a first RFID tag;
determining whether said first identifier code of said first RFID tag is associated with said one or more advertising programs; and
producing a first incentive message corresponding to said at least one of said one or more advertising programs if at least said first identifier code is determined to be associated with said at least one of said one or more advertising programs.

10. The method of claim 9, wherein the step of producing the first incentive message comprises transmitting an electronic message to a first phone number, wherein said first phone number is paired with said first identifier code.

11. The method of claim 10, wherein said electronic message comprises an electronic coupon.

12. The method of claim 10, further comprising requesting a zip code.

13. The method of claim 10, further comprising validating said first incentive message.

14. The method of claim 13, wherein the step of validating said first incentive message comprises determining whether said first incentive message has already been redeemed.

15. The method of claim 9, further comprising collecting advertising information in real-time based upon the production of a set of incentive messages and redemption of said set of incentive messages.

16. The method of claim 9, further comprising before the step of producing said first incentive message, determining whether said first incentive message should be produced based upon predetermined business rules.

17. The method of claim 9, wherein the step of producing said first incentive message comprises printing a coupon.

18. A method of advertising using a mobile device, the method comprising:
receiving at least one identifier code to a target phone number from the phone number of a mobile device and pairing the phone number of said mobile device to said at least one identifier code in a database, wherein said at least one identifier code corresponds to data encoded on the integrated circuit of an RFID tag;
transmitting a list message to the phone number of said mobile device, wherein said list message contains a list of commercial establishments;
receiving a selection message containing one or more selections from said list of commercial establishments;
associating the phone number of said mobile device and said at least one identifier code to at least one advertising program based at least partially upon said one or more selections; and
producing one or more incentive messages relating to said one or more selections based at least upon the detection of said data encoded on said RFID tag.

19. The method of claim 18, further comprising receiving a zip code from the phone number of said mobile device.

20. The method of claim 18, wherein said one or more incentive messages comprises an e-mail.
